(19) United States
(12) Patent Application Publication
(10) Pub. No.: US 2009/0246526 A1
(43) Pub. Date: Oct. 1, 2009

(54) FERRITE PARTICLES AND PRODUCTION METHOD THEREOF

(75) Inventors: Takao SUGIURA, Kashiwa-shi (JP); Takashi HIKICHI, Matsudo-shi (JP); Yoshinori KUSAKA, Tsukubamirai-shi (JP); Satoru TANIGUCHI, Kashiwa-shi (JP); Tadashi HARAYAMA, Kashiwa-shi (JP); Hiromichi KOBAYASHI, Nagareyama-shi (JP)

Correspondence Address: GREENBLUM & BERNSTEIN, P.L.C., 1950 ROLAND CLARKE PLACE, RESTON, VA, 20191, US

(73) Assignee: Powdertech Co., Ltd., Chiba (JP)

(21) Appl. No.: 12/410,644

(22) Filed: Mar. 25, 2009

(30) Foreign Application Priority Data
Mar. 26, 2008 (JP) 2008-081704

(51) Int. Cl. B32B 5/16; C04B 35/64; C04B 35/26

(52) U.S. Cl. 428/402; 252/62.56

(57) ABSTRACT

A method for producing ferrite particles by weighing, mixing, then crushing ferrite raw materials, and granulating the resultant slurry, and then sintering the resultant granulated material using a rotary furnace, wherein the sintering is carried out under a positive pressure reducing atmosphere.

### BACKGROUND OF THE INVENTION

1. Field of the Invention

The present invention relates to ferrite particles and a production method thereof. More particularly, the present invention relates to ferrite particles which can be obtained at low cost with the particles being uniform and stable, and a production method thereof.

2. Description of the Related Art

Conventionally, tunnel furnaces and batch furnaces have been used as the sintering furnace used in the production of ferrite particles. In these sintering furnaces, since the ferrite raw material powder is fed into a vessel such as a saggar to carry out the sintering, the ferrite raw material powder is heated in a static state without being fluidized. Thus, agglomeration among the particles and composition variation of the ferrite particles due to reactions with the vessel occur. Further, since the particles cannot be uniformly heated, not only does the surface become uneven, but the ferritization reaction also becomes uneven, so that the distribution of the magnetic properties broadens.

A method for producing ferrite particles and magnetite particles has been proposed, which uses a sintering furnace which has fluidizing means such as a rotation type sintering furnace (rotary furnace) as a sintering furnace instead of such tunnel furnaces and batch furnaces.

Japanese Patent Laid-Open No. 2-255539 discloses a method for producing ferrite particles by carrying out in order a step of wet mixing a raw material powder, a step of spraying in which the size of the particles is adjusted to 10 to 100 μm, and a step of stirring and sintering at 1,100 to 1,200° C. to obtain a ferrite powder. Further, in the stirring and sintering step, a rotary kiln provided with a blade, for example, is used.

Further, WO 2005/062132 discloses a method for producing a resin-coated carrier for an electrophotographic developer by weighing the ferrite raw materials, mixing them, then crushing the mixture, granulating the resultant slurry, sintering, and coating with a resin, in which the sintering is carried out at a sintering temperature of 1,200° C. while fluidizing the granulated material by fluidizing means. A rotation type sintering furnace, namely, a rotary kiln is illustrated as the fluidizing means.

WO 2005/073147 discloses a method for producing a ferrite sintered body having a specific composition, especially a method for producing a W-type ferrite sintered body, which includes a calcining step, a first crushing step, a heat treatment step, a second crushing step, a step of molding in a magnetic field, and a sintering step. Further, a tubular furnace is used in the calcining step.

Japanese Patent Laid-Open No. 2005-281069 discloses a method for producing a ferrite composition having a step of preparing a ferrite slurry which contains a ferrite raw material and a solvent, a step of charging the ferrite slurry into a rotary kiln in the slurry state, and a step of carrying out in the rotary kiln all at once drying and removal of the solvent from the slurry and calcination of the ferrite raw material. According to this production method, production efficiency can be improved and production costs can be reduced without a reduction in electromagnetic properties such as core loss.

Further, Japanese Patent Laid-Open No. 2006-160559 discloses magnetite powder formed by reducing hematite, in which a layered bumpy pattern with 5 to 80 nm gaps on the particle surface is observed in an atomic force microscope image. Further, in this reduction, a specially configured rotary kiln is used which keeps the furnace interior as a reducing atmosphere by introducing a reducing gas, so that the desired magnetite powder can be safely and stably obtained.

When such a sintering furnace having fluidizing means, especially a rotation type sintering furnace (rotary furnace), is used to sinter ferrite particles and the like, since the particles are heated in a fluidized state, the particles are heated uniformly. As a result, such method has the advantages that unevenness among the particles is small, temperature control is simple, property control is easy, and the atmosphere control is simple because the furnace is basically sealed.

However, in the above-described conventional art, when a rotation type sintering furnace (rotary furnace) is used to sinter ferrite particles and the like, there are the following problems. Specifically, (1) when used at high temperatures, the retort life is short, and powder adheres inside the retort, so that the heating efficiency changes over time, which makes stable production difficult; (2) when the ferrite is sintered, while a certain amount of heating time is required, there are limits on extending the residence time in the furnace just by adjusting the rotation number, the raw material supply rate, and the retort length; and (3) chlorine derived from the raw materials tends to remain in the sintered material, and if that amount is too large, there is an adverse impact on the properties of the sintered material.

As a proposal to resolve some of these problems, Japanese Patent Laid-Open Nos. 2002-81866 and 2003-42668 disclose methods for removing adhered matter on the rotary kiln walls in which an adhered matter removal member having three or more blades in a peripheral direction of the center axis is arranged. However, such a method does not fundamentally resolve all of the above-described problems occurring when a rotation type sintering furnace (rotary furnace) is used to sinter ferrite particles and the like.

Thus, a method is yet to be obtained, with which, in the production of ferrite particles and the like using a rotary furnace, the amount of adhered matter in the rotary furnace is reduced and good sintering efficiency is provided so that a stable sintered material can be obtained using low-cost equipment over a long period of time, and which can reduce the adverse effects of chlorine on the sintered material.

### SUMMARY OF THE INVENTION

Therefore, it is an object of the present invention to provide a method for producing ferrite particles, with which the amount of adhered matter in the rotary furnace is reduced and good sintering efficiency is provided so that a stable sintered material can be obtained using low-cost equipment over a long period of time, and which can reduce the adverse effects of chlorine on the sintered material.

As a result of extensive investigations to resolve the above-described problems, the present inventors discovered that, in a method for producing ferrite particles by carrying out sintering using a rotary furnace, the ferritization reaction could be promoted even at low temperatures by carrying out the sintering under a reducing atmosphere in a state where the furnace interior pressure is made positive with respect to the furnace exterior pressure, thereby arriving at the present invention.

Specifically, the present invention provides a method for producing ferrite particles by weighing, mixing, then crushing ferrite raw materials, and granulating the resultant slurry, and then sintering the resultant granulated material using a rotary furnace, wherein the sintering is carried out under a positive pressure reducing atmosphere.

In the method for producing ferrite particles according to the present invention, the reducing atmosphere is preferably formed by a reducing gas generated by heating a component contained in the ferrite raw materials.

In the method for producing ferrite particles according to the present invention, the pressure inside the rotary furnace is preferably 10 Pa or more.

In the method for producing ferrite particles according to the present invention, the rotary furnace is preferably provided with a mechanism for removing adhered matter in the furnace. Examples of such a mechanism include a rotating body inside the furnace and/or a means which applies blows from outside of the furnace.

In the method for producing ferrite particles according to the present invention, the sintering temperature in the sintering is preferably 800 to 1,180° C.

In the method for producing ferrite particles according to the present invention, it is preferred to provide a mechanism for adjusting the amount of chlorine atoms.

In the method for producing ferrite particles according to the present invention, it is preferred to have, after the sintering step, a step of removing chlorine and/or a step of controlling magnetic and electrical resistance properties.

Further, the present invention provides ferrite particles obtained by the above-described production method.

The ferrite particles according to the present invention are preferably porous ferrite particles having a pore volume of 0.03 to 0.20 mL/g and a peak pore size of 0.2 to 0.7 μm.

The ferrite particles according to the present invention preferably have an apparent density of 1.2 to 2.5 g/cm³.

The ferrite particles according to the present invention preferably have a chlorine content of not greater than 800 ppm.

The ferrite particles according to the present invention are preferably used in a carrier for an electrophotographic developer.

According to the method for producing the ferrite particles of the present invention, since a sufficient ferritization reaction can be obtained even at low temperatures, the amount of adhered matter in a rotary furnace can be reduced and a sintered material which is stable over a long period of time can be obtained. Further, even without providing a measure such as lengthening the retort, since the sintering efficiency is equivalent to that where the residence time in the furnace was extended, the stable sintered material can be obtained using low-cost equipment. In addition, since the amount of chlorine in the raw materials can be adjusted to an arbitrary amount, adverse effects on the properties of the sintered material due to chlorine are reduced, and such adverse effects can be controlled.

Further, the ferrite particles obtained by the production method according to the present invention, especially porous ferrite particles have a pore volume and a peak pore size in a fixed range, and a reduced chlorine content.

### DETAILED DESCRIPTION OF THE PREFERRED EMBODIMENTS

Preferred embodiments for carrying out the present invention will now be described.

### <Method for Producing the Ferrite Particles According to the Present Invention>

In the method for producing ferrite particles according to the present invention, the ferrite raw materials are weighed and mixed, then the resultant mixture is crushed, and the resultant slurry is granulated. Then, the resultant granulated material is sintered using a rotary furnace. The production method according to the present invention will now be described in more detail.

First, the ferrite raw materials are appropriately weighed, and then are crushed and mixed by a ball mill, vibration mill or the like for 0.5 hours or more, and preferably for 1 to 20 hours. The raw materials are not especially limited, but the composition of the ferrite particles obtained preferably includes at least one selected from the group consisting of Fe, Mn, Mg, Li, Ca, Sr, Ti, Zr, Cu, Zn, and Ni. Considering the recent trend towards reducing environmental load, such as restrictions on waste products, it is preferable for the heavy metals Cu, Zn and Ni to be contained in an amount which does not exceed the scope of unavoidable impurities (accompanying impurities).

The resultant crushed material is pelletized using a pressure molding machine or the like, and calcined at a temperature of 700 to 1,200° C. This may also be carried out without using a pressure molding machine, by adding water to form a slurry after the crushing, and then granulating using a spray drier. The calcined material is further crushed by a ball mill, vibration mill or the like, then charged with water, and optionally with a dispersant, a binder or the like to adjust viscosity, and the resultant slurry is granulated using a spray drier. In the case of crushing after calcination, the calcined material may be charged with water and crushed by a wet ball mill, wet vibration mill or the like.

The above crushing machine such as the ball mill or vibration mill is not especially limited, but, for uniformly and effectively dispersing the raw materials, preferably uses fine beads having a particle size of 1 mm or less as the media to be used. By adjusting the size, composition and crushing time of the used beads, the crushing degree can be controlled.

Subsequently, the obtained granulated material is sintered using a rotary furnace. In the present invention, this sintering is carried out under a positive pressure reducing atmosphere. By carrying out the sintering under such a condition, the ferritization reaction is promoted, and sintering at low temperatures becomes possible. In cases such as a reducing atmosphere but a negative pressure, or a positive pressure but not a reducing atmosphere state (an oxidizing atmosphere or an inert atmosphere), since the ferritization reaction does not proceed easily, low-temperature sintering cannot be achieved, the raw materials tend to adhere inside the rotary furnace, and the sintering does not proceed. Moreover, variations in the sintering state occur over time. Here, the term “positive pressure” refers to the state where the pressure inside the furnace is higher than the pressure outside the furnace.

Although this reducing atmosphere can be obtained by charging in a reducing gas such as hydrogen and carbon monoxide, the reducing atmosphere is preferably formed by a reducing gas generated by heating the components which are contained in the above-described ferrite raw materials. In the raw materials which are usually used to obtain ferrite particles, C (carbon) and H (hydrogen) components derived from the various used materials are contained. Examples of the origin raw materials include the dispersant, moistening agent, surfactant and the like used to disperse the metal oxide, which will serve as the main component in the ferrite, in the slurry, and the binder component (PVA, PEG, PVP etc.) used to form the particles. The reducing atmosphere can be formed by heating these ferrite raw materials.

These origin raw materials are included in each of the particles, so that all of the particles are exposed to a uniform reducing atmosphere. As a result, a sintered material free from unevenness among the particles can be obtained. A method which introduces hydrogen gas and carbon monoxide gas to produce the reducing atmosphere increases costs and makes it difficult for all of the particles to uniformly come into contact with the reducing atmosphere. As a result, unevenness tends to occur in the sintered material.

The pressure of the rotary furnace is preferably 10 Pa or more. If the furnace interior pressure is less than 10 Pa, it is difficult for the ferritization reaction to proceed. When sintering for a long time at a high temperature, such as in a tunnel furnace, the ferritization reaction easily proceeds even if the pressure is not that high. However, when carrying out the sintering using a rotary furnace at a low temperature, if the pressure is low, it is difficult for the ferritization to proceed. Here, the term “pressure” refers to the pressure difference between outside and inside the furnace.

In the rotary furnace, it is preferred to provide a mechanism for removing adhered matter in the furnace. Even if the granulated material is sintered using a rotary furnace at a low temperature, at a positive pressure, and under a reducing atmosphere, a small amount of adhered matter may be produced in the furnace. Such adhered matter in the furnace can gradually increase from long-term running, which can result in a reduction in heat efficiency so that the sintering is not carried out sufficiently. Thus, to remove the adhere matter in the furnace which is produced from long-term running, it is preferred to provide in the rotary furnace a mechanism for removing adhered matter in the furnace.

Examples of such a mechanism include a rotating body inside the furnace and/or a means which applies blows from outside of the furnace. Adhered matter with a relatively weak adhesion force can be easily removed by applying blows from outside of the furnace, while adhered matter with a relatively strong adhesion force can be removed by placing a member which rotates in the furnace, and letting this rotating body scrape off the adhered matter in the furnace.

The sintering temperature in the sintering is preferably 800 to 1,180° C. If the sintering temperature is less than 800° C., it is difficult for the ferritization reaction to proceed, while if the sintering temperature is more than 1,180° C., the amount of adhered matter in the furnace increases, the heating efficiency changes over time, and it is difficult to obtain ferrite particles which are a stable sintered material.

In the production method of the present invention, it is preferred to provide a mechanism for adjusting the amount of chlorine atoms. Generally, chlorine or chlorides are included as impurities in the iron oxide (Fe₂O₃) which is the main raw material of the ferrite. This is because when industrially producing ferrite, the main raw material Fe₂O₃ is produced by roasting the ferrous chloride which is obtained from a steel pickling waste liquid. For typical industrial product grade, several tens of ppm to several hundreds of ppm are contained as chlorine atoms. The chlorine compounds which are formed by the residual chlorine atoms easily adsorb moisture in the air, and can thus affect the properties of the ferrite particles, especially electrical resistance. Basically, the amount of chlorine atoms in the ferrite particles after sintering is preferably as small as possible. However, the residual chlorine atoms contained in the sintered ferrite particles are derived from the raw materials, and thus change depending on the raw material lot. Therefore, to consistently obtain stable properties, it is preferred to control the amount of contained or residual chlorine atoms to a fixed amount. As the method for controlling the amount of chlorine using a rotary furnace, it is preferred to introduce a fixed amount of gas into the furnace, produce a gas flow in the furnace, and cause the chlorine compounds gas formed during the sintering to be expelled out of the furnace. The gas which is introduced to remove the chlorine is not especially limited as long as the furnace interior can maintain a reducing atmosphere. By appropriately adjusting the introduced gas and furnace interior pressure, the chlorine can be efficiently removed and controlled. Further, the chlorine may be efficiently removed and controlled also by adding the below-described secondary and/or tertiary sintering.

In the production method according to the present invention, after the sintering step (primary sintering), it is preferred to add a step of removing chlorine (secondary sintering) and/or a step of controlling magnetic and electrical resistance properties (tertiary sintering). In the sintering step (primary sintering), by suitably adjusting the atmosphere, temperature, furnace interior pressure, and other conditions (rotation number of the rotary furnace, incline, raw material charging amount etc.), the objects of the present invention can be achieved even by one-stage sintering (primary sintering). However, to obtain uniform sintered material more stably, after the primary sintering step for carrying out the ferritization reaction and crystal growth, it is preferred to combine a sintering step of removing chlorine (secondary sintering) and/or a step of controlling magnetic and electrical resistance properties (tertiary sintering).

Here, the step of removing chlorine (secondary sintering) is a step in which produced chlorine gas is removed by actively introducing a gas from outside of the furnace while heating. The step of controlling magnetic and electrical resistance properties (tertiary sintering), in cases where the properties could not be sufficiently controlled in the sintering step (primary sintering), or where the properties deviated from a desired level due to the following step of removing chlorine (secondary sintering), is a step of heating so that the required properties are obtained. In the step of controlling magnetic and electrical resistance properties (tertiary sintering), the oxygen concentration is adjusted and heating is carried out to obtain the desired magnetic and electrical resistance properties. While the step of removing chlorine (secondary sintering) as well as the step of controlling magnetic and electrical resistance properties (tertiary sintering) may both use any form of furnace as long as it is a heating furnace, it is preferred to use a rotary furnace. This is because a rotary furnace is preferred in order to remove efficiently and uniformly remove the chlorine and to obtain a sintered material having uniform properties.

The resultant sintered material is crushed and classified. The particles are adjusted to a desired size using a conventionally-known classification method, such as air classification, mesh filtration and precipitation.

Thereafter, the electrical resistance can be optionally adjusted by heating the surface at a low temperature to carry out an oxide film treatment. The oxide film treatment may be conducted using a common furnace such as a rotary electric furnace or batch-type electric furnace, and the heat-treatment may be carried out, for example, at 300 to 700° C. Reduction may optionally be carried out before the oxide film treatment.

### <Ferrite Particles According to the Present Invention>

Since the ferrite particles obtained by the above-described production method according to the present invention are subjected to uniform heating, and since there are not many agglomerations among the particles generated during the sintering, there is very little unevenness among the particles in terms of particle properties. Further, since the chlorine content is suitably reduced, the properties such as electrical resistance are stable.

The ferrite particles according to the present invention are porous ferrite particles having uniform pores on the particle surface and in the particle interior. The pore volume of these ferrite particles is preferably 0.03 to 0.20 mL/g, and the peak pore size is preferably 0.2 to 0.7 μm. Further, the apparent density of the ferrite particles is preferably 1.2 to 2.5 g/cm³.

Since the apparent density of the powder prior to sintering is about 1.0 g/cm³ and the pore volume is about 0.25 mL/g, when the apparent density is less than 1.2 g/cm³, or when the pore volume is more than 0.20 mL/g, the sintering can be said to have hardly proceeded.

Pore volume, peak pore size, and pore size unevenness may be controlled in various ways, for example, according to the kind of raw material to be blended, the crushing degree of the raw materials, whether calcination is carried out, the calcination temperature, the calcination time, the binder amount during granulation by a spray dryer, the sintering conditions (the sintering temperature, the sintering time etc.) and the like. These control methods are not especially limited. One such example will now be described below.

Specifically, a pore volume tends to increase when a hydroxide or a carbonate is used as the raw material species to be blended compared with when an oxide is used. Further, pore volume tends to increase, if calcining is not carried out, or if the calcination temperature is low, or if the sintering temperature is low or the sintering time is short.

A peak pore size tends to decrease by increasing the crushing degree of the used raw materials, especially the raw materials after calcining, to make the crushed primary particles finer. Further, peak pore size can be changed also by the amount of reducing gas introduced or generated during sintering.

Further, pore size unevenness can be reduced by uniformly advancing the sintering properties of the raw materials during sintering. A rotary electric furnace is preferred for this point. Further, pore size unevenness can also be reduced by increasing the crushing degree of the used raw materials, especially the raw materials after calcining, to make the crushed particle size distribution sharper.

By carrying out these control methods individually or in combination, porous ferrite particles having desired pore volume, peak pore size, and pore size unevenness can be obtained.

Because of the above-described reasons, these ferrite particles preferably have a chlorine atom content controlled to not greater than 800 ppm, more preferably not greater than 600 ppm, and most preferably not greater than 100 ppm.

The thus-obtained ferrite particles may be used in various applications. Specific examples include electromagnetic wave absorbents, filler powders in paints, and various magnetic powder applications. However, the thus-obtained ferrite particles may be suitably used especially as a carrier application for an electrophotographic developer, as is, as a resin-coated ferrite carrier coated with various resins on the surface, or as a resin-filled ferrite carrier obtained by filling a resin in pores of the porous ferrite carrier.

### <Measurement Method>

The measurement methods of the below-illustrated examples were as follows.

### [Pore Volume and Peak Pore Size]

Measurement of the pore size and the pore volume of ferrite particles may be carried out in the following manner. Specifically, measurement was carried out using mercury porosimeters Pascal 140 and Pascal 240 (manufactured by Thermo Fisher Scientific). Using a CD3P (for powder) as a dilatometer, a sample was placed in a commercially-available capsule made from gelatin which had a plurality of opened holes, and this capsule was then placed in the dilatometer. After evacuating with the Pascal 140, mercury was filled therein. The low pressure region (0 to 400 kPa) was measured, and the results were taken as the first run. Next, evacuation and measurement of the low pressure region (0 to 400 kPa) were again carried out, and the results were taken as the second run. After the second run, the combined weight of the dilatometer, the mercury, the capsule, and the sample was measured. Next, the high pressure region (0.1 MPa to 200 MPa) was measured using the Pascal 240. Using the mercury penetration obtained by the measurement of this high pressure portion, the pore volume and peak pore size of the ferrite particles were determined. Further, when determining the pore size, the surface tension of the mercury was calculated as 480 dyn/cm and the contact angle as 141.3°.

### [Apparent Density (JIS Method)]

Measurement of this apparent density is carried out according to JIS-Z2504 (metal powder apparent density test methods). The details are as follows.

### 1. Apparatus

A powder apparent densimeter is used which is configured from a funnel, a cup, a funnel support, a support bar and a support base. A balance is used which has a reciprocal sensibility of 50 mg in weighing 200 g.

### 2. Measurement Method

(1) The sample is set to at least 150 g or more.
(2) The sample is poured into the funnel, which has an orifice with a pore size of 2.5^{+0.2/-0} mm, until the sample poured through the funnel has filled a cup and overflows.
(3) When the sample begins to overflow, the inflow of the sample is immediately stopped, and the sample risen above the cup is flatly scraped off along the upper end of the cup by a spatula so as not to impart vibration.
(4) The side of the cup is lightly struck to settle the sample. The sample adhered to the outside of the cup is removed, and the weight of the sample in the cup is weighed at an accuracy of 0.05 g.

### 3. Calculation

A numerical value obtained by multiplying the measurement value obtained from the above 2 (4) by 0.04 is rounded to the second decimal place according to JIS-Z8401 (how to round a numerical value), and taken as the apparent density with units of “g/cm³”.

### (Electrical Resistance)

Non-magnetic parallel plate electrodes (10 mm×40 mm) are made to face each other with an inter-electrode interval of 6.5 mm. 200 mg of a sample is weighed and filled between the electrodes. The sample is held between the electrodes by attaching a magnet (surface magnetic flux density: 1500 Gauss, surface area of electrode in contact with the magnet: 10 mm×30 mm) to the parallel plate electrodes, and a 100 V voltage is applied in order. The resistance for the respective applied voltages was measured by an insulation resistance tester (SM-8210, manufactured by DKK-TOA Corporation). The measurement was carried out in a constant temperature, constant humidity room controlled at a temperature of 25° C. and a humidity of 55%.

### (Volume Average Particle Size)

The average particle size was measured described below, that is, using a Microtrac Particle Size Analyzer (Model: 9320-X100), manufactured by Nikkiso Co., Ltd. Water was used for the dispersing medium. A 100 mL beaker was charged with 10 g of a sample and 80 mL of water, and then 2 to 3 drops of a dispersant (sodium hexametaphosphate) were added therein. Next, using the ultrasonic homogenizer (Model: UH-150, manufactured by SMT Co. Ltd.), the output was set to level 4, and dispersing was carried out for 20 seconds. Then, the bubbles formed on the surface of the beaker were removed, and the sample was charged into the analyzer.

### (Chlorine Content Measurement Method)

The amount of chlorine atoms contained in the sintered ferrite particles was measured using an X-ray fluorescence elemental analyzer.

Used as the measuring apparatus was a “ZSX 100s” manufactured by Rigaku Corporation. About 5 g of a sample was placed in a powder sample vessel for vacuum, which was then attached to the sample folder. The amount of C1 was then determined using the above measuring apparatus. The measurement conditions were that a C1-Kα line was taken as the measuring line, tube voltage was 50 kV, tube current was 50 mA, Ge was used for the analyzing crystal, and a PC (proportional counter) was used as the detector.

### (Magnetic Properties)

Measurement of the magnetic properties was carried out using an integral-type B-H tracer BHU-60 (manufactured by Riken Denshi Co., Ltd.). An H coil for measuring magnetic field and a 4 πI coil for measuring magnetization were placed in between electromagnets. In this case, the sample was put in the 4 πI coil. The outputs of the H coil and the 4 πI coil when the magnetic field H was changed by changing the current of the electromagnets were each integrated; and with the H output as the X-axis and the 4 πI coil output as the Y-axis, a hysteresis loop was drawn on recording paper. The measuring conditions were a sample filling quantity of about 1 g, the sample filling cell had an inner diameter of 7 mmφ±0.02 mm and a height of 10 mm±0.1 mm, and the 4 πI coil had a winding number of 30.

The present invention will now be described in more detail based on the following examples. However, the present invention is in no way limited to these examples.

### EXAMPLE 1

Raw materials were weighed out in a ratio of 35 mol % of MnO, 14.5 mol % of MgO, 50 mol % of Fe₂O₃ and 0.5 mol % of SrO. The resultant mixture was crushed for 5 hours by a wet media mill to obtain a slurry. This slurry was dried by a spray dryer to obtain spherical particles. Manganomanganic oxide was used for the MnO raw material, magnesium hydroxide was used for the MgO raw material, and strontium carbonate was used as the SrO raw material. The particles were adjusted for particle size, and then heated for 2 hours at 950° C. to carry out calcination. Subsequently, the particles were crushed for 1 hour by a wet ball mill using stainless steel beads ⅛ inch in diameter, and then crushed for a further 4 hours using stainless steel beads 1/16 inch in diameter. The slurry was charged with an appropriate amount of dispersant. To ensure the strength of the particles to be granulated, the slurry was also charged with 0.6% by weight of PVA (20% solution) based on solid content as a binder. The slurry was then granulated and dried by a spray drier. The size of the resultant particles was then adjusted.

The resultant granulated material was held under a reducing atmosphere at a set temperature of 900° C. for 1 hour in a rotary electric furnace to carry out sintering. The furnace interior pressure was 10 to 80 Pa. As a mechanism for removing the adhered matter in the furnace interior, a “knocker” (blows from outside the furnace) was used. Further, the reducing atmosphere utilized a thermal decomposition gas of the dispersant and the binder added during granulation by the spray drier.

Then, the sintered material was crushed and further classified for particle size adjustment. Low magnetic particles were then separated off by magnetic separation to obtain porous ferrite particles. These porous ferrite particles had a pore volume of 0.124 mL/g and a peak pore size of 0.485 μm.

### EXAMPLE 2

Porous ferrite particles were obtained in the same manner as in Example 1, except that after the sintering (primary sintering), the below step for removing chlorine (secondary sintering) and the below step for controlling the magnetic properties and electrical resistance properties (tertiary sintering) were carried out.
Step for Removing Chlorine (secondary sintering)
Sintering Method: Rotary Furnace
Atmosphere: Air
Set Temperature: 1,050° C.
Furnace Interior Pressure: 0 Pa
Mechanism for Removing Adhered Matter in the Furnace: Knocker (blows from outside the furnace)
Step for Controlling the Magnetic Properties and Electrical Resistance Properties (tertiary sintering)
Sintering Method: Rotary Furnace
Atmosphere: N₂
Set Temperature: 1,050° C.
Furnace Interior Pressure: 0 to 10 Pa
Mechanism for Removing Adhered Matter in the Furnace: Knocker (blows from outside the furnace)

### EXAMPLE 3

Porous ferrite particles were obtained in the same manner as in Example 1, except that the sintering (primary sintering) conditions were a set temperature of 1,050° C., a furnace interior pressure of 100 to 130 Pa, and a rotating body inside the furnace was used for the mechanism for removing adhered matter in the furnace.

### EXAMPLE 4

Porous ferrite particles were obtained in the same manner as in Example 3, except that after the sintering (primary sintering), the below step for controlling the magnetic properties and electrical resistance properties (tertiary sintering) was carried out.
Step for Controlling the Magnetic Properties and Electrical Resistance Properties (tertiary sintering)
Sintering Method: Rotary Furnace
Atmosphere: N₂
Set Temperature: 1,050° C.
Furnace Interior Pressure: 0 to 10 Pa
Mechanism for Removing Adhered Matter in the Furnace: Knocker (blows from outside the furnace)

### EXAMPLE 5

Porous ferrite particles were obtained in the same manner as in Example 1, except that the sintering (primary sintering) conditions were a set temperature of 850° C. and a furnace interior pressure of 150 to 200 Pa.

### EXAMPLE 6

Porous ferrite particles were obtained in the same manner as in Example 1, except that the sintering (primary sintering) conditions were a set temperature of 1,000° C. and a furnace interior pressure of 150 to 200 Pa.

### COMPARATIVE EXAMPLE 1

Porous ferrite particles were obtained in the same manner as in Example 1, except that the sintering (primary sintering) conditions were an atmosphere of air, a set temperature of 1,050° C., and a furnace interior pressure of 0 Pa, and that a mechanism for removing adhered matter in the furnace was not used.

### COMPARATIVE EXAMPLE 2

Porous ferrite particles were obtained in the same manner as in Comparative Example 1, except that after the sintering (primary sintering), the below step for controlling the magnetic properties and electrical resistance properties (tertiary sintering) was carried out.
Step for Controlling the Magnetic Properties and Electrical Resistance Properties (tertiary sintering)
Sintering Method: Rotary Furnace
Atmosphere: N₂
Set Temperature: 1,050° C.
Furnace Interior Pressure: 0 to 50 Pa
Mechanism for Removing Adhered Matter in the Furnace: None

### COMPARATIVE EXAMPLE 3

Porous ferrite particles were obtained in the same manner as in Example 1, except that the sintering (primary sintering) conditions were an atmosphere of N₂ and a furnace interior pressure of 0 to 5 Pa.

### COMPARATIVE EXAMPLE 4

Porous ferrite particles were obtained in the same manner as in Example 1, except that the sintering (primary sintering) conditions were an atmosphere of N₂, a set temperature of 1,050° C., and a furnace interior pressure of 0 to 5 Pa.

The sintering conditions (sintering method, atmosphere, set temperature, furnace interior pressure, and mechanism for removing adhered matter in the furnace) of Examples 1 to 6 and Comparative Examples 1 to 4 are shown in Table 1. Further, the various properties (pore volume, peak pore size, apparent density, electrical resistance, volume average particle size, chlorine content, and magnetization) of the obtained porous ferrite particles are shown in Table 2.

TABLE 1

| | First Stage Sintering | | | | | Second Stage Sintering (Step of Removing Chlorine) | | | | |
|---|---|---|---|---|---|---|---|---|---|---|
| | | | | Furnace | Mechanism for | | | | Furnace | Mechanism for |
| | | | Set | interior | Removing | | | Set | interior | Removing |
| | Sintering | | Temperature | pressure | Adhered Matter | Sintering | | Temperature | pressure | Adhered Matter |
| | Method | Atmosphere | (° C.) | (Pa) | in the Furnace | Method | Atmosphere | (° C.) | (Pa) | in the Furnace |
| Example 1 | Rotary | Reducing | 900 | 10-80 | Knocker (blows | | | | | |
| | Furnace | | | | from outside the | | | | | |
| | | | | | furnace) | | | | | |
| Example 2 | Rotary | Reducing | 900 | 10-80 | Knocker (blows | Rotary | Air | 1050 | 0 | Knocker |
| | Furnace | | | | from outside the | Furnace | | | | (blows from |
| | | | | | furnace) | | | | | outside the |
| | | | | | | | | | | furnace) |
| Example 3 | Rotary | Reducing | 1050 | 100-130 | Rotating Body | | | | | |
| | Furnace | | | | Inside the | | | | | |
| | | | | | Furnace | | | | | |
| Example 4 | Rotary | Reducing | 1050 | 100-130 | Rotating Body | | | | | |
| | Furnace | | | | Inside the | | | | | |
| | | | | | Furnace | | | | | |
| Example 5 | Rotary | Reducing | 850 | 150-200 | Knocker (blows | | | | | |
| | Furnace | | | | from outside the | | | | | |
| | | | | | furnace) | | | | | |
| Example 6 | Rotary | Reducing | 1000 | 150-200 | Knocker (blows | | | | | |
| | Furnace | | | | from outside the | | | | | |
| | | | | | furnace) | | | | | |
| Comparative | Rotary | Air | 1050 | 0 | None | | | | | |
| Example 1 | Furnace | | | | | | | | | |
| Comparative | Rotary | Air | 1050 | 0 | None | | | | | |
| Example 2 | Furnace | | | | | | | | | |
| Comparative | Rotary | N₂ | 900 | 0-5 | Knocker (blows | | | | | |
| Example 3 | Furnace | | | | from outside the | | | | | |
| | | | | | furnace) | | | | | |
| Comparative | Rotary | N₂ | 1050 | 0-5 | Knocker (blows | | | | | |
| Example 4 | Furnace | | | | from outside the | | | | | |
| | | | | | furnace) | | | | | |

| | Third Stage Sintering (Step of Controlling Magnetic | | | | |
|---|---|---|---|---|---|
| | Properties and Electrical Resistance Properties) | | | | |
| | | | | Furnace | Mechanism for |
| | | | Set | interior | Removing |
| | Sintering | | Temperature | pressure | Adhered Matter |
| | Method | Atmosphere | (° C.) | (Pa) | in the Furnace |
| Example 1 | | | | | |
| Example 2 | Rotary | N₂ | 1050 | 0-10 | Knocker (blows |
| | Furnace | | | | from outside |
| | | | | | the furnace) |
| Example 3 | | | | | |
| Example 4 | Rotary | N₂ | 1050 | 0-10 | Knocker (blows |
| | Furnace | | | | from outside |
| | | | | | the furnace) |
| Example 5 | | | | | |
| Example 6 | | | | | |
| Comparative | | | | | |
| Example 1 | | | | | |
| Comparative | Rotary | N₂ | 1050 | 0-50 | None |
| Example 2 | Furnace | | | | |
| Comparative | | | | | |
| Example 3 | | | | | |
| Comparative | | | | | |
| Example 4 | | | | | |

TABLE 2

| | | | | | Volume | | |
|---|---|---|---|---|---|---|---|
| | Pore | | Apparent | Electrical | Average | Chlorine | Magnetization |
| | Volume | Peak Pore | Density | Resistance | Particle Size | Content | at 3 kOe |
| | (ml/g) | Size (μm) | (g/cm3) | (Ω) | d50 (μm) | (ppm) | (Am2/kg) |
| Example 1 | 0.124 | 0.49 | 1.45 | 4.0 × 10⁷ | 38.4 | 517 | 65 |
| Example 2 | 0.105 | 0.49 | 1.52 | 8.0 × 10⁸ | 38.9 | <10 | 72 |
| Example 3 | 0.036 | 0.44 | 1.96 | 2.4 × 10⁷ | 38.5 | 498 | 73 |
| Example 4 | 0.032 | 0.41 | 1.97 | 2.2 × 10⁷ | 41.0 | 80 | 72 |
| Example 5 | 0.174 | 0.49 | 1.26 | 1.0 × 10⁷ | 37.1 | 568 | 67 |
| Example 6 | 0.058 | 0.49 | 1.63 | 4.1 × 10⁶ | 38.4 | 527 | 61 |
| Comparative | 0.209 | 0.49 | 1.16 | 1.1 × 10⁹ | 36.3 | <10 | 25 |
| Example 1 | | | | | | | |
| Comparative | 0.221 | 0.5 | 1.13 | 1.6 × 10⁸ | 39.2 | <10 | 68 |
| Example 2 | | | | | | | |
| Comparative | 0.229 | 0.53 | 1.06 | 8.4 × 10⁶ | 34.7 | 254 | 35 |
| Example 3 | | | | | | | |
| Comparative | 0.239 | 0.55 | 1.05 | 1.9 × 10⁸ | 35.9 | 91 | 63 |
| Example 4 | | | | | | | |

As is clear from the results shown in Table 2, the porous ferrite particles described in Examples 1 to 6 had an apparent density of more than 1.2 g/cm³ and a magnetization also of more than 60 emu/g, and thus sufficient ferritization was achieved. Further, chlorine content also varied according to the step, showing that suitable adjustment could be carried out.

Based on these results, when used as a carrier for electrophotography, or even when used as a carrier for electrophotography after being further filled or coated with a resin, it can be inferred that the porous ferrite particles described in Examples 1 to 6 would achieve the desired properties.

On the other hand, the particles described in Comparative Examples 1 to 4 had a low apparent density and a large pore volume. The pre-sintering particles had an apparent density of about 1.0 g/cm³, and a pore volume of about 0.25 mL/g. Thus, it can be seen that the particles described in Comparative Examples 1 to 4 had hardly changed from those prior to sintering, so that the ferritization reaction and crystal growth had not proceeded.

Thus, if the carrier obtained in Comparative Examples 1 to 4 was actually used, it can be easily imagined that the particles would break from the stresses in an actual machine, and that the resultant fluctuations in properties would be large.

According to the method for producing the ferrite particles according to the present invention, since a sufficient ferritization reaction can be obtained even at low temperatures, the amount of adhered matter in a rotary furnace can be reduced and a sintered material which is stable over a long period of time can be obtained. Further, even without providing a measure such as lengthening the retort, since the sintering efficiency is equivalent to that where the residence time in the furnace was extended, the sintered material can be obtained using low-cost equipment. In addition, since the amount of chlorine in the raw materials can be adjusted to an arbitrary amount, adverse effects on the properties of the sintered material due to chlorine are reduced, and such adverse effects can be controlled.

Since the thus-obtained ferrite particles, especially porous ferrite particles, have a pore volume and a peak pore size which are in a fixed range, and a reduced chlorine content, the thus-obtained ferrite particles may be suitably used especially as a carrier application for an electrophotographic developer as is, as a resin-coated ferrite carrier coated with various resins on the surface, or as a resin-filled ferrite carrier obtained by filling a resin in pores of the porous ferrite particles.

1. A method for producing ferrite particles by weighing, mixing, then crushing ferrite raw materials, and granulating the resultant slurry, and then sintering the resultant granulated material using a rotary furnace, wherein the sintering is carried out under a positive pressure reducing atmosphere.

2. The method for producing ferrite particles according to claim 1, wherein the reducing atmosphere is formed by a reducing gas generated by heating a component contained in the ferrite raw materials.

3. The method for producing ferrite particles according to claim 1, wherein the pressure inside the rotary furnace is 10 Pa or more.

4. The method for producing ferrite particles according to claim 1, wherein the rotary furnace is provided with a mechanism for removing adhered matter in the furnace.

5. The method for producing ferrite particles according to claim 4, wherein the mechanism for removing adhered matter in the furnace is a rotating body inside the furnace and/or a means which applies blows from outside of the furnace.

6. The method for producing ferrite particles according to claim 1, wherein the sintering temperature in the sintering is 800 to 1,180° C.

7. The method for producing ferrite particles according to claim 1, wherein a mechanism for adjusting the amount of chlorine atoms is provided.

8. The method for producing ferrite particles according to claim 1, which comprises, after the sintering step, a step of removing chlorine and/or a step of controlling magnetic and electrical resistance properties.

9. Ferrite particles obtained by the production method of claim 1.

10. The ferrite particles according to claim 9, wherein the ferrite particles are porous, and have a pore volume of 0.03 to 0.20 mL/g and a peak pore size of 0.2 to 0.7 μm.

11. The ferrite particles according to claim 9, wherein the apparent density is 1.2 to 2.5 g/cm³.

12. The ferrite particles according to claim 9, wherein the chlorine content is not greater than 800 ppm.

13. The ferrite particles according to claim 9, which are used in a carrier for an electrophotographic developer.
